(19) United States
(12) Patent Application Publication
(10) Pub. No.: US 2006/0187071 A1
(43) Pub. Date: Aug. 24, 2006

(54) System and method for notification of power system status

(75) Inventors: Philip Ted Kortum, Austin, TX (US); Marc Andrew Sullivan, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/056,936

(22) Filed: Feb. 11, 2005

(51) Int. Cl. G08B 21/00

(52) U.S. Cl. 340/635

(57) ABSTRACT

The present disclosure provides a system and method for providing a verbal status of a power system utilizing a telephone system. A remote diagnostics module can communicate a status signal to a reporting module or an audio reporting system. The audio reporting system can be configured to dial a telephone number of the user's telephone and provide verbal notification to a user of a specific operating parameter of a power system. A reporting module can notify a central reporting system or a local reporting system. The status may be the condition of a battery.

### FIELD OF THE DISCLOSURE

The present disclosure relates generally to notification techniques and more particularly to a system and method for notification of power system status.

### BACKGROUND

In an effort to extend high-speed communication services to individual households, communication providers are beginning to implement fiber to the premises offerings (FTTP). FTTP systems provide fiber optic cables from a network aggregation point like a telephone company central office to users in residential neighborhoods or to commercial locations. The FTTP systems being deployed appear to promise residential users a significant bandwidth increase over other last mile solutions. But, this increase in bandwidth may come at a cost and with a few new challenges.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 presents a simplified configuration of a fiber to the premise system that incorporates teachings of the present disclosure;

FIG. 2 illustrates a block diagram of one example of a power system for a fiber to the premise system; and

FIG. 3 illustrates a flow diagram of a method for monitoring a fiber to the premise power system.

### DETAILED DESCRIPTION OF THE DRAWINGS

The present disclosure provides a system and method for notifying a user of power system parameters. This notification may involve, for example, utilizing a telephone system to provide a verbal message describing an operational characteristic of a power system supporting some portion of an FTTP implementation. For example, a remote diagnostics module may communicate a status signal to a reporting module or an audio reporting system. The audio reporting system may be configured to dial a telephone number of the user's telephone and to provide some verbal notification to a user of a specific operating parameter of the power system. The operating parameter may be, for example, the condition of a battery and/or the amount of charge time remaining in a given battery. Depending on implementation detail, the reporting module may operate by notifying a central reporting system and/or a local reporting system.

In a typical copper based telephone system, the power to support a basic user phone system is provided over copper wires. As such, if there is a power outage, the phone system will usually continue to function, as the telephone company can often select from multiple power sources such as an onsite generation.

Unlike a copper-based solution, FTTP systems do not utilize deployed fiber to carry power to the premises. In an FTTP system, an AC to DC converter may be plugged into a premises power outlet to power at least a localized portion of the FTTP system. The AC to DC converter may be necessary to convert the 110 Volts of alternating current that typically comes from a wall outlet to the 80 volts of direct current that an FTTP system may need. As a result, if a power company has a power outage, an FTTP-based telephone system at a residence can become inoperable. If the outage is local, an individual utilizing an FTTP phone system may not be able to call the power company to report the outage.

Auxiliary power or battery back-up power can be added to FTTP telephone systems to maintain phone service during a power outage. As long as the battery can provide adequate power, the FTTP telephone service may remain operational. Many phone subscribers believe it is critical to maintain phone service during power outages and, as such, may choose to utilize a battery back-up system. As depicted in the Figures, a deployed battery back-up system can present power status information using several modalities. One of the several modalities may involve a visual indicator. For example, a “status” light or light emitting diodes (LED's) may be used to notify a user of the status of the battery or the power system generally. From a practical perspective, many batteries have relatively short lifetimes and a status indicator can indicate if the battery is in need of replacement. However, if the power fails, the visual indicator may also fail.

A system incorporating the teachings disclosed herein may couple visible warning lights and/or localized beeping options with a more proactive notification technique such as a telephone call. As mentioned above, a status LED and/or beeper may be placed outside a premises where an optical line connection may be made to the house. If an FTTP termination point is placed outside the premises, these indicators may go unnoticed by the user. If the power system is installed inside a premises, a user may be confronted with aesthetic and/or space issues, as the batteries and converter can be the size of a suitcase. Interior installation may also require holes to be drilled in the exterior walls of the house to provide power from a wall outlet in the home to the optical termination outside the home.

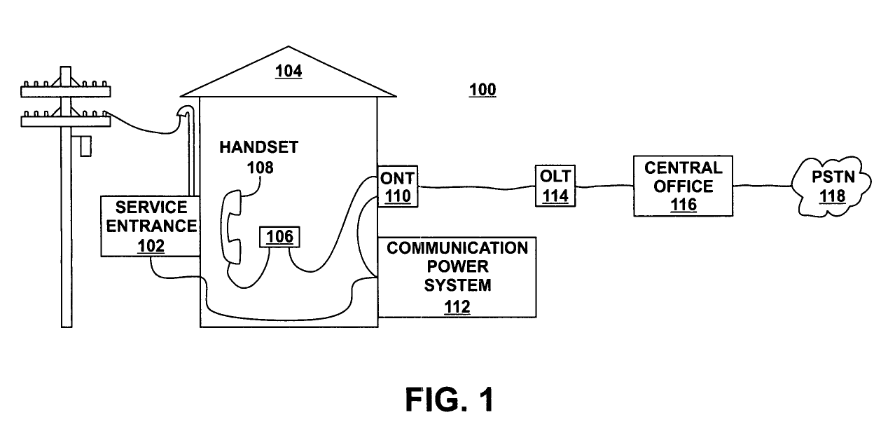

Referring to FIG. 1, a power monitoring system 100 configured to provide a voice based status indication to a user over a telephone network is described. The system can include a service entrance 102, a communication power system 112, an optical network terminal (ONT) 110, and a telephone terminal 106 having a handset 108. The service entrance 102 may be placed on an exterior wall of a premises such as house 104. Optical network terminal 110 may be coupled to optical line terminal (OLT) 114 and optical line terminal 114 may be coupled to central office 116. Central Office 116 may be part of public switched telephone network (PSTN) 118. When power is unavailable at service entrance 102, batteries within the communication power system 112 may provide power to the optical network terminal 110 and to the telephone terminal 106 such that the user can communicate to others via central office 116 and the PSTN 118. Moreover, as the level of power in the batteries of communication power system 112 begins to deteriorate, a subscriber residing at house 104 may be notified via a telephone call and/or message converged by handset 108.

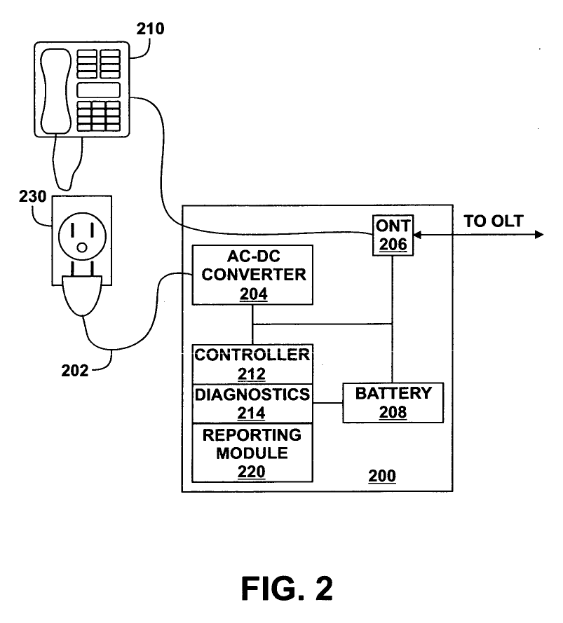

Referring to FIG. 2 a more detailed description of a communication power system 200 is illustrated. System 200 can include an AC-to-DC converter 204 coupled via power cord 202 to an outlet 230. AC-to-DC converter 204 may be coupled to a controller 212, a diagnostics module 214, and a reporting module 220. AC-to-DC converter 204 may also be coupled to battery 208 and to optical network terminal 206. Depending upon implementation detail, the optical network terminal 206 can be coupled to telephone receiver-transmitter 210 and to an optical line terminal and a PSTN (not shown). The receiver-transmitter 210 may also include local voice-messaging services. Although one battery is illustrated, the battery 208 could include many batteries and although many components in FIG. 2 are illustrated in an integrated configuration, components such as the optical network terminal 206 or the battery 208 could be separately packaged without parting from the scope of the present disclosure.

In operation, power is provided to wall outlet 230 by a power company, and power cord 202 conveys 110 Volts of alternating current (AC) to AC-to-DC converter 204. The AC-to-DC converter 204 can convert the 110 volts of alternating current into 80 volts of direct current (DC). The 80 VDC output of the AC-to-DC converter can be coupled to the ONT 206, which may utilize the power to process signals and to power the telephone receiver-transmitter 210. In the event that power in unavailable at the outlet 230 or in the event the AC-to-DC converter 204 fails, battery 208 may be switched into the power circuit by controller 212 to provide power to the system. A seamless transition could occur such that even if the user is talking on the phone during a power outage, no interruption in service would occur.

During normal operation, and during back-up operation, diagnostics module 214 may monitor battery parameters such as battery age, voltage, temperature, time till discharge, charge rate, discharge rate, time till charge, and chemical composition of battery 208. Controller 212 may manipulate input and output parameters of the battery 208 such that the diagnostics module 214 can gather data on the battery 208. Charging and discharging of the battery 208 may be controlled based on the diagnostic data. If diagnostic module 214 determines that the battery's condition or the condition of some other power system component has deviated from a normal condition then diagnostic module 214 can send a signal to reporting module 220. In response, reporting module 220 may rely on one or more modalities to notify the user that an abnormality has been detected.

In one example, reporting module 220 may call telephone receiver-transmitter 210. The reporting module 220 may detect a recent phone usage and subsequently ring the receiver-transmitter 210 and provide audio such as, “Your batteries need replacing and you can order replacement batteries by calling SBC at 1-800-123-4567 or by dialing the following short dialing sequence, *99.” If there is no answer on the receiver-transmitter 210, a message could be left in voice mail on receiver-transmitter 210.

In another example, reporting module 220 could be located remotely such as at a central office. Reporting module 220 could send a message over the telephone network (not shown) to a central office, and the telephone service provider may then send a message to the user receiver-transmitter 210 from a centralized location or a remote location.

In yet another example a central diagnostic system can communicate with diagnostics module 214 and gather information from the power monitor system 200 or a remote location at predetermined time intervals. The diagnostic message could be sent to and/or forwarded to a centralized messaging system (not shown). Additionally an e-mail message could be sent by the reporting module 220, to the users e-mail and/or a message could be sent via regular mail. Reporting module 220 could contain a list of user contact information and a preferred method of notification. For example, a user may want to be notified via a cellular telephone or a personal digital assistant and the method and contact number could be stored by the system. This method of contacting a user of telephone power system status helps minimize the need for location critical installations of power systems and can greatly reduce installation costs. An additional benefit of the disclosed system is that a telephone service provider can monitor a users power system and if desired can send out notices and can advertise replacement parts specific to the users, provide specific part numbers and provide a method for electronic based purchases.

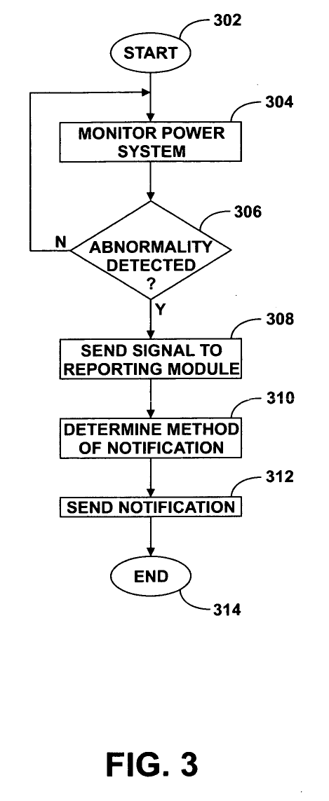

Referring to FIG. 3 a method for monitoring telephone system power is illustrated. The method starts at step 302 and proceeds to step 304 where a power system is monitored. At decision block 306 it is determined if an abnormality in the power system is detected. If system operation is normal, the process proceeds back to 304 and continues monitoring the power system. If an abnormality is detected, an indicator is sent to a reporting module at step 308. The reporting module can determine a preferred method of notification and contact information to be utilized to notify the user at step 310. The notification is sent at step 312 and the process ends at 314.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a power monitor configured to provide a status signal based on a condition of a power system to a user of a telephone system; and
an audio reporting system coupleable to the power monitor and configured to dial a telephone number of the telephone system and provide verbal notification to a user of the condition of the power system.

2. The system of claim 1, further comprising an optical line terminal coupled to the power monitor.

3. The system of claim 1, further comprising a reporting module coupled to the optical network terminal, wherein the reporting module notifies a central reporting system and the central reporting system provides notification to the user.

4. The system of claim 1, further comprising a diagnostic module wherein a remote terminal can communicate with the diagnositc module to obtain a status of the power system.

5. The system of claim 3, further comprising at least one battery coupled to the power monitor wherein the reporting module can report a status of the battery.

6. The system of claim 1, further comprising a diagnostic module coupled to the power system and configured to perform diagnostics on the power system.

7. The system of claim 1, wherein the status is a status of a battery.

8. The system of claim 1, wherein the status is a status of an AC to DC converter.

9. A method of monitoring a telephone power system comprising:
comparing an operational power parameter of a telephone system to a threshold level;
locating an electronic address of a user of the telephone system; and
providing an audible notification of the operational parameter to the electronic address if the parameter is below the threshold level.

10. The method of claim 9, further comprising personalizing the audible notification.

11. The method of claim 10, wherein the parameter is one of a power level, and a battery condition.

12. The method of claim 1, wherein the predetermined electronic address is one of a telephone number, an e-mail, a street address, a web-interface, a mobile telephone number, an Internet address, and a pager number.

13. The method of claim 9, wherein the electronic address is a telephone number of a telephone service provider.

14. The system of claim 9, wherein the audible notification contains speech specific to the operational parameter.

15. The system of claim 9, wherein the audible notification provides a method for providing parts having an operational parameter that is below the threshold level.

16. A method comprising:
monitoring a power system configured to provide power to a premise;
detecting abnormalities in the power system;
transmitting a notification to the premise when the abnormalities are detected.

17. The method of claim 16, wherein the transmitting includes transmitting a notification to a voice response system wherein the voice response system transmits audio to the premise.

18. The method of claim 16, wherein the notification is transmitted to a voice mailbox.

19. The method of claim 16, wherein the notification is provided in the audible form of “Your battery needs to be replaced.”

20. The method of claim 16, further comprising advertising replacement parts to the user based on the abnormality and provides a system configured to receive a parts order.
